(19) United States
(12) Patent Application Publication
(10) Pub. No.: US 2010/0132571 A1
(43) Pub. Date: Jun. 3, 2010

(54) Former Arrangement

(75) Inventor: Wolfgang Hiesinger, Biberbach (DE)

Correspondence Address: COHEN, PONTANI, LIEBERMAN & PAVANE LLP, 551 FIFTH AVENUE, SUITE 1210, NEW YORK, NY, 10176, US

(73) Assignee: Manroland AG, Offenbach am Main (DE)

(21) Appl. No.: 12/628,885

(22) Filed: Dec. 1, 2009

(30) Foreign Application Priority Data
Dec. 2, 2008 (DE) 10 2008 044 251.8

(51) Int. Cl. B41F 5/04

(52) U.S. Cl. 101/219

(57) ABSTRACT

A former arrangement for processing a substrate web in a reel-fed printing press having at least three formers which are arranged adjacent to each other and transversely to a web running direction of the substrate web and at least five longitudinal slitting devices for the longitudinal slitting of the substrate web in at least two part webs which are arranged offset to each other in the web running direction in front of the at least three formers and transversely to the web running direction, wherein the at least three formers and the longitudinal slitting devices are each separately moveable transversely to the web running direction.

### BACKGROUND OF THE INVENTION

1. Field of the Invention

The invention is directed to a former arrangement and, more particularly, to a former arrangement for processing a substrate web in a reel-fed printing press.

2. Description of the Related Art

Former arrangements having at least two formers of which at least one former is transversely moveable are known from EP 1 604 931 B1. Former arrangements are also known for XXL-news plants, where the former arrangements are designed for processing a substrate web in accordance with a six page wide production and which merely comprise symmetrically displaceable formers. Such known former arrangements require special productions to be run by way of turner bars and, if applicable, additional formers.

### SUMMARY OF THE INVENTION

It is therefore an object of the invention to provide a former arrangement that provides a high level of processing flexibility for different quantities of print pages arranged in the web width direction, as well as for different web widths of the substrate.

This and other objects and advantages are achieved with a former arrangements for processing a substrate web in a reel-fed printing press which comprises at least three formers arranged adjacent to one another and transversely to the web running direction of the substrate web. In addition, at least five longitudinal slitting devices are arranged in the web running direction in front of the at least three formers and are arranged transversely to the web running direction offset to one another for longitudinal slitting the substrate web into at least two part-webs.

The at least three formers and the at least five longitudinal slitting devices can each be separately moved transversely to the web running direction. Consequently, a high level of processing flexibility is guaranteed for different quantities of print pages arranged in the web width direction of a substrate web, where the variable web widths can be run or produced both in the middle and outside the middle of the longitudinal axis of a printing press machine.

In accordance with an embodiment of the invention, the at least three formers can be moved to a plurality of predetermined positions corresponding to a four page wide, a five page wide or a six page wide production, respectively. With this configuration, it is possible to quickly, repeatably and securely set predetermined production configurations in a simple manner. Thus, setting time, waste, and costs can be saved in a simple manner.

In accordance with another embodiment of the invention, the at least three formers are each continuously moveable in a predetermined region in their respective positions so that the positions of the at least three formers are adaptable to web widths which are continuously selectable in the predetermined region. Thus, in connection with the advantageous rapid preselection of the positions defining the respective production configuration, for example, additional flexibility of the selection of the web width to be processed is guaranteed.

In accordance with a further embodiment of the invention, a lead-in roller pair and a nipping roller pair arranged downstream of the web running direction and a frame moveable transversely to the web running direction in accordance with the predetermined positions and in the predetermined region are provided for each former, where a respective former, an associated lead-in roller pair and an associated nipping roller pair are mounted in the frame so that the respective former, the associated lead-in roller pair and the associated nipping roller pair can be jointly moved with the frame. With this configuration, it is advantageously possible to transfer the selection of a certain production configuration quickly and easily to the lead-in rollers and the nipping rollers. Thus, additional setting time, waste, and costs can be saved in a simple manner.

In yet another embodiment of the invention, at least two adjacent formers of the at least three formers are provided with a comb section on adjacent facing sides of the at least three formers in an upper region of these faces so that the at least two formers engage in each other in at least one of the predetermined positions in a comb-like manner. With this configuration, it is possible in a simple manner to arrange the adjacent formers transversely to the web running direction as seen in a line one after the other (or adjacent to each other as seen in the web running direction), where the adjacent formers, depending on the web width and selected quantity of print pages distributed over the web width (e.g., four page wide, five page wide or six page wide production) engaging each other in a comb-like manner, can overlap or directly adjoin each other.

In accordance with another embodiment, all formers of the at least three formers located adjacent to one another are each provided with a comb section on facing sides of the formers in an upper region of these faces so that the adjacent formers engage in one another in a comb-like manner at a predetermined position. With this configuration, it is possible in a simple manner to arrange all formers of the former arrangement transversely to the web running direction as seen in a line one after the other (or as seen adjacent to one another in the web running direction), where the respective adjacent formers, depending on the web width and selected quantity of print pages distributed over the web width (e.g., four page wide, five page or six page wide production), can overlap or directly adjoin one another to thereby engage each other in a comb-like manner.

In a further particular advantageous embodiment, middle formers of the at least three formers arranged between two outer formers of the at least three formers, on each of the sides facing the outer formers in the upper region, are each provided with a comb section so that the middle formers in at least one of the predetermined positions are engaged in a comb-like manner with the two outer formers.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, the invention is explained in more detail by means of preferred embodiments and making reference to the enclosed figures, in which:

FIG. 1A to FIG. 1C show a plurality of different production configurations of the former arrangement with web lead in the printing press middle in accordance with the invention;

FIG. 2 is an enlarged view of a pair of exemplary six page wide configurations of the former arrangement of FIG. 1A;

FIG. 3 is an enlarged view of a pair of five page wide configurations of the former arrangement of FIG. 1B;

FIG. 4 is an enlarged view of a pair of four page wide configurations of the former arrangement of FIG. 1C;

FIGS. 5A to 5B show a plurality of production configurations of the former arrangement with a web lead outside the printing press middle in accordance with the invention;

FIG. 6 shows an embodiment of the former arrangement with printing press components arranged downstream in accordance with the invention;

FIG. 7 shows further embodiments of the former arrangement configured in accordance with the invention; and

FIG. 8 shows alternative embodiments of the former arrangement configured in accordance with the invention.

### DETAILED DESCRIPTION OF THE PREFERRED EMBODIMENTS

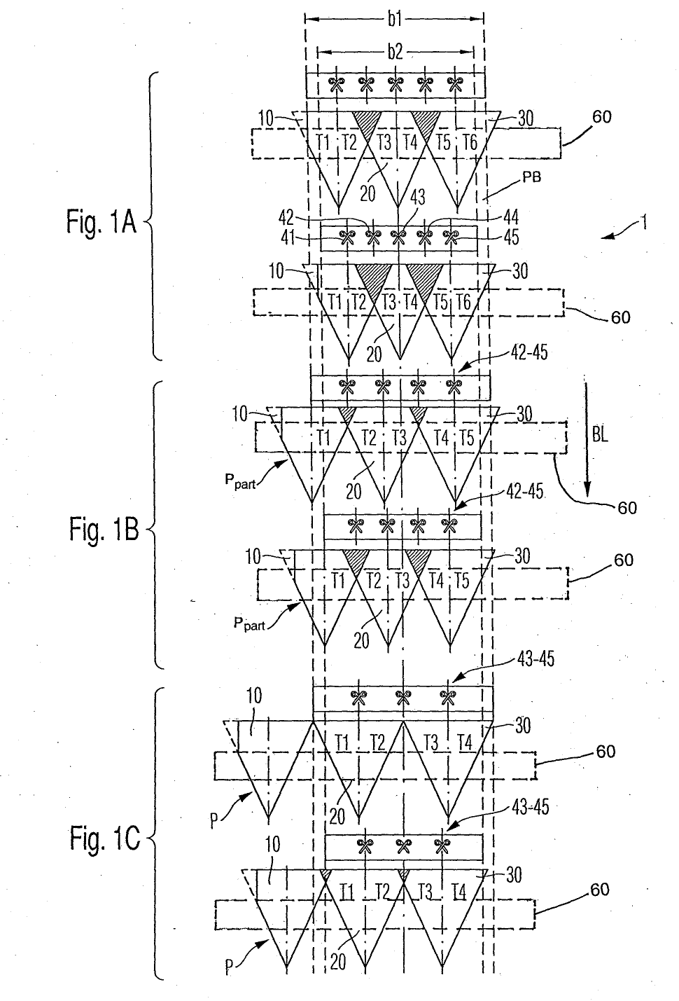

FIGS. 1A to 8 show exemplary embodiments of production configurations of a former arrangement 1 for processing a substrate web PB in accordance with the invention.

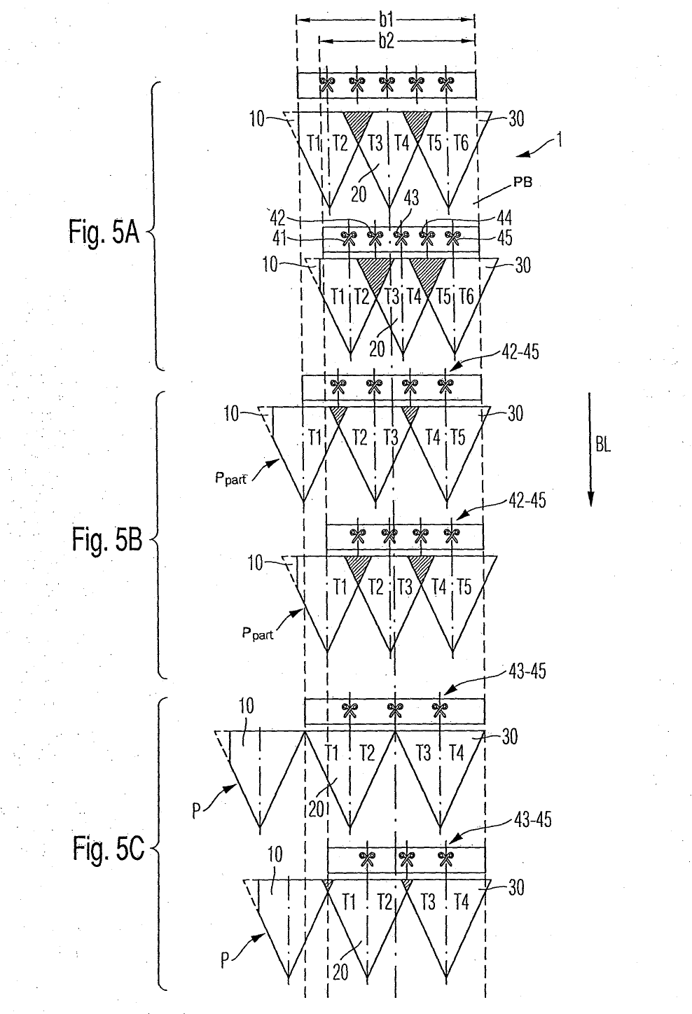

As specifically shown in FIGS. 1A, 1B, 5 and 6, the former arrangement 1 is part of a reel-fed printing press (not shown completely and not designated for purposes of clarity) and comprises at least three formers 10, 20 and 30 which are arranged transversely to a web running direction BL of the substrate web PB and adjacent to one another in the horizontal direction, as well as at least five longitudinal slitting devices 41 to 45 which are arranged in the web running direction BL in front of the at least three formers 10, 20, 30 and are offset to one another transversely to the web running direction BL. (All five of the longitudinal slitting devices are only shown in FIGS. 1A and 5A of the FIGS. 1 and 5). Here, the at least five longitudinal slitting devices 41 to 45 are preferably arranged in the horizontal direction adjacent to one another and transversely to the web running direction BL, as seen in a line for longitudinally slitting the substrate web PB into at least two and a maximum of six part webs T1 to T6.

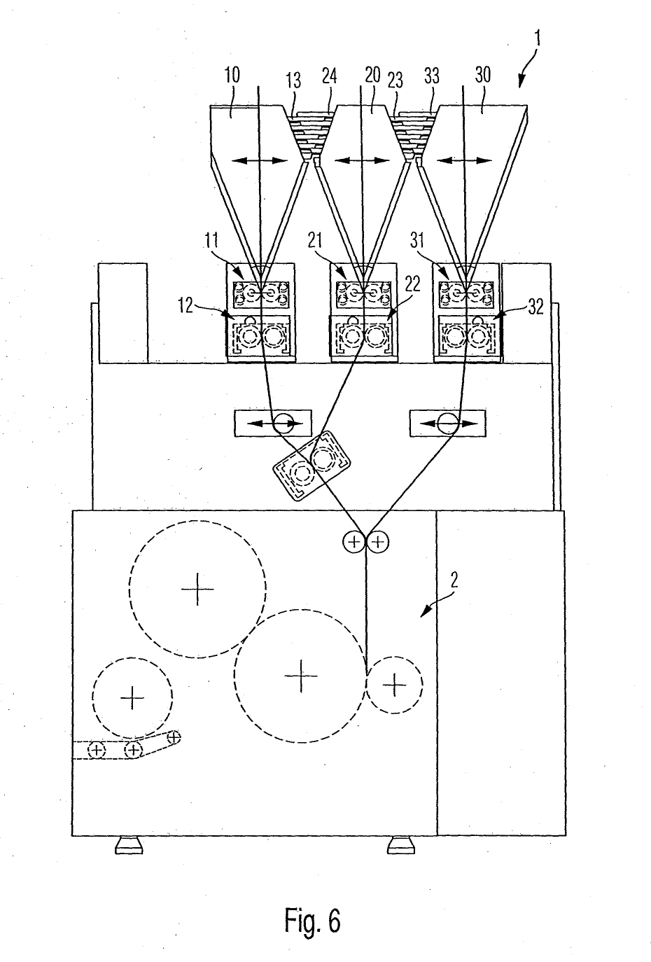

As shown in FIGS. 6, 7 and 8, each former 10, 20 and 30 comprises a lead-in roller pair 11, 21 and 31 and a nipping roller pair 12, 22 and 32 arranged downstream of the formers in the web running direction BL. Furthermore, a folder 2 is preferably arranged downstream of the former arrangement 1.

As indicated by the respective double arrows in FIG. 6, the at least three formers 10, 20, 30 and the at least five longitudinal slitting devices 41 to 45 are each separately moveable and lockable transversely to the web running direction BL. More precisely, the at least three formers 10, 20, 30 and the five longitudinal slitting devices 41 to 45 are each moveable and lockable in a plurality of predetermined positions corresponding to a four page wide, a five page wide or a six page wide production.

In each respective position, the at least three formers 10, 20, 30 and the longitudinal slitting devices 41 to 45 are each continuously moveable and lockable in a predetermined region so that the positions of the at least three formers 10, 20, 30 and the positions of the longitudinal slitting devices 41 to 45 are configurable to web widths which are continuously selectable in the predetermined region.

Each of the at least three formers 10, 20, 30 and their associated lead-in roller pair 11, 21, 31 and associated nipping roller pair 12, 22, 32 are mounted in a frame 60 which is moveable transversely to the web running direction BL according to the plurality of predetermined positions and in the predetermined region (see, e.g., FIGS. 1A to 1C).

The respective frame can be moved and locked via a linear guide (not shown), locking means (not shown) as well as by an optional motor adjusting drive (not shown) transversely to the web running direction BL according to the plurality of predetermined positions and in the predetermined region so that a corresponding former 10, 20, 30, the associated lead-in roller pair 11, 21, 31 and the associated nipping roller pair 11, 22, 32 can be jointly moved and locked with the frame.

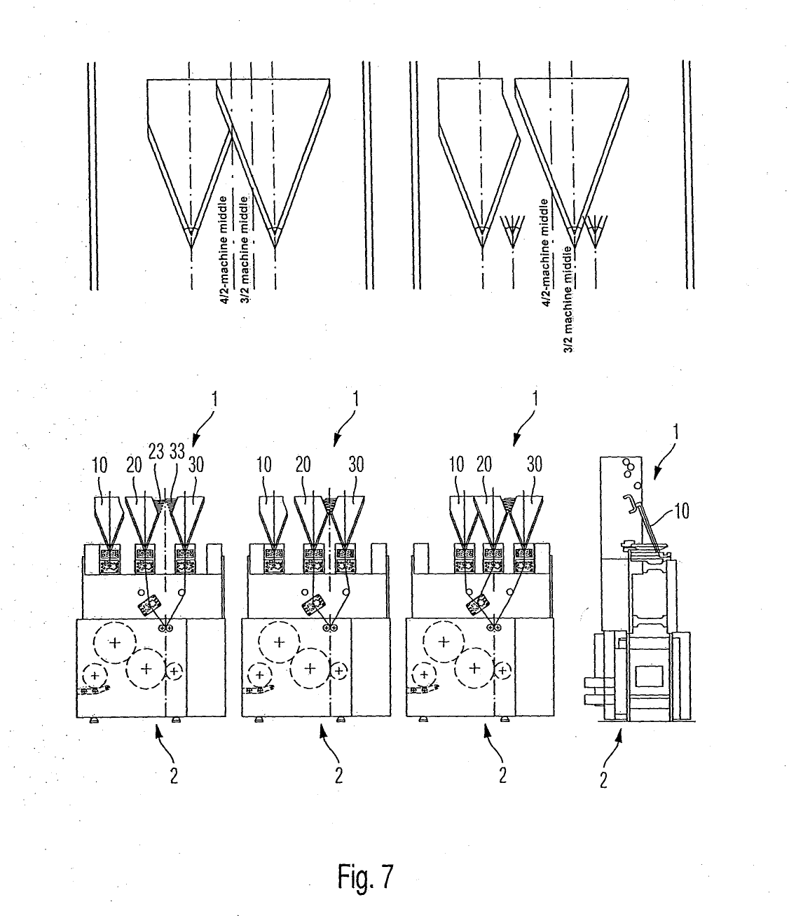

Furthermore, each of the longitudinal slitting devices 41 to 45 comprises a linear guide (not shown), locking means (not shown), as well as an optional motor adjusting drive (not shown) to guarantee the respective individual adjustability of each longitudinal slitting device 41 to 45 transversely to the web running direction BL, as well as to guarantee their individual lockability. As evident from FIGS. 6 and 7, at least two adjacent formers 20 and 30 (see the lower arrangement depicted in FIG. 7, i.e., the middle former 20 and the right former 30) of the at least three formers 10, 20, 30 on adjacent facing sides of the formers are each preferably provided with a comb section 23 or 33 in an upper region of the adjacent sides so that the two formers 20, 30 engage in each other in at least one of the plurality of predetermined positions.

In accordance with the exemplary embodiment depicted in the lower section of FIG. 7, the left former 10 located on the side facing the middle former 20 is recessed or cut in an upper region of this side so that the left former 10 and the middle former 20 can be moved into a position relative to each other in which their uncut contours would overlap each other.

With reference to FIG. 6, in accordance with an embodiment of the former arrangement, all formers 10 and 20, as well as 20 and 30 of the at least three formers 10, 20, 30, which are adjacent to each other on each of the adjacent facing sides, can each be preferably provided with a comb section 13, 23, 24 and 33 in the upper region of the adjacent faces so that each of the adjacent formers 10 and 20, as well as 20 and 30, engage in each other in a comb-like manner, in which the comb teeth are alternatingly interposed or interleaved, in at least one of the plurality of predetermined positions.

As shown in FIG. 6, the middle former 20, which is arranged between the two outer formers 10, 30 on each of the sides facing the outer formers 10, 30, comprises a comb section 23 and 24 that is located in each upper region of these side faces so that the middle former 20 is engaged in at least one of the plurality of predetermined positions in a comb-like manner with the two outer formers 10, 30.

The disclosed embodiments of the former arrangement 1 depicted in FIGS. 6 and 7 make it possible to arrange all formers 10, 20, 30 of the former arrangement 1 transversely to the web running direction BL, as seen in a line one after the other (or as seen adjacent to one another in the web running direction BL), where the respective adjacent formers 10 and 20, as well as 20 and 30, depending on the web width and selected quantity of print pages distributed over the web width (e.g., four page wide, five page wide or six page wide production) overlap engaging in each other in a comb-like or quasi manner, overlap each other through the recess, or directly adjoin each other.

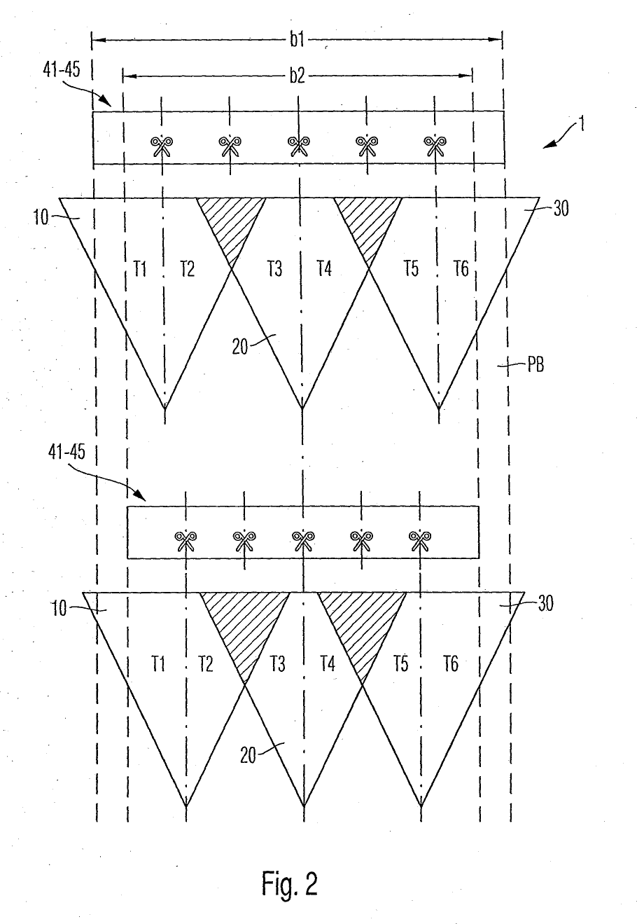

With specific reference to FIGS. 1A to 5, shown therein are exemplary embodiments of different production configurations for the former arrangement 1 in accordance with the invention. Here, FIG. 1A shows a plurality of embodiments of production configurations of the former arrangement 1 with a web lead in the printing press middle. That is, FIG. 1A shows a first embodiment of a production configuration of the former arrangement 1 with a web lead in the printing press middle, where along the web width, which can vary between, for example, a maximum width b1 and a minimum web width b2, six print pages are arranged adjacent to one another. FIG. 2 shows an enlarged view of the production configurations of FIG. 1A.

Returning to FIG. 1A, the substrate web PB is longitudinally cut into six part webs T1 to T6 of identical width using the at least five longitudinal slitting devices 41 to 45 so that each part web T1 to T6 carries a print page along the part web width. Here, the at least three formers 10, 20, 30 are each moved to a position corresponding to a six page wide production so that the six part webs T1 to T6 can each be guided with one of their longitudinal edges to the middle of a respective associated former 10, or 30 while aligned via the respective formers 10, 20, 30.

A respective former 10, 20 or 30 associated with a part web T1 to T6 functions as a turner bar that continuously reverses the associated part web T1 to T6 from a horizontal web run into a vertical web run and is turned at this location by 90°, so that the exemplary part webs T1 to T6 placed one on top of the another can be jointly fed to the folder 2, as shown in FIG. 6, for example.

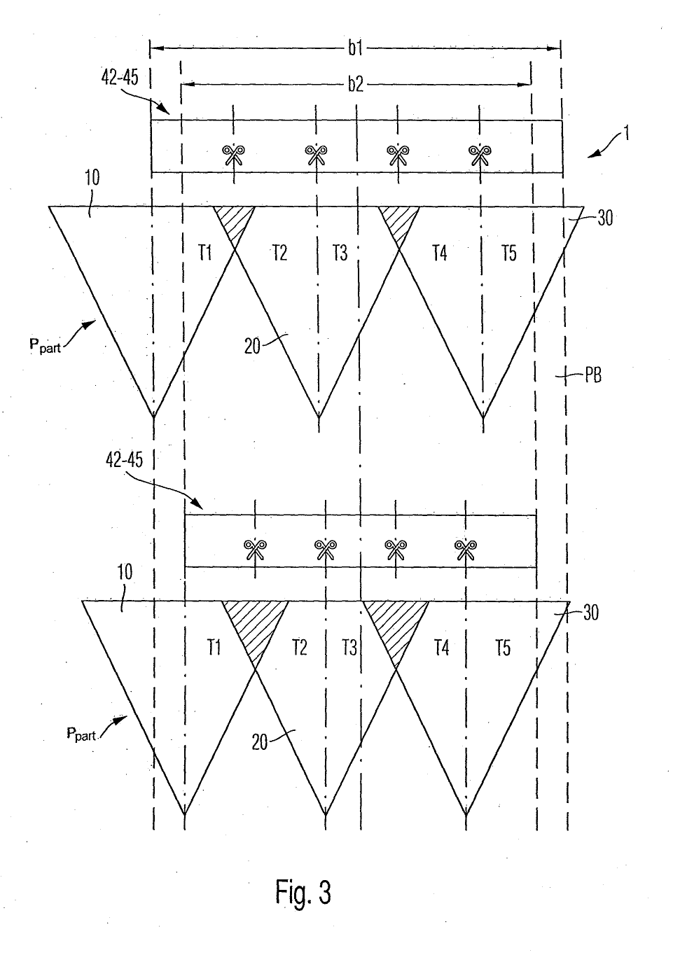

FIG. 1B shows a second embodiment of a production configuration of the former arrangement 1 with a web lead in the printing press middle, where along the web width, which can vary between, for example, the maximum web width b1 (see the upper view of FIG. 1B) and a minimum web width b2 (see lower view of FIG. 1B), with five print pages being arranged adjacent to one another. FIG. 3 shows an enlarged view of the production configurations of FIG. 1B.

With reference to FIG. 1B, the substrate web PB is longitudinally cut by four longitudinal slitting devices 42 to 45 (the fifth longitudinal slitting device 41 being non-operational) into five part webs T1 to T5 of equal width, so that each part web T1 to T5 carries a print page along the part web width. Here, each of the at least three formers 10, 20, 30 are moved to a position corresponding to a five page wide production so that the five part webs T1 to T5 can each be guided with one of their longitudinal edges to the middle of an associated former 10, 20 or 30 while aligned via the respective formers 10, 20, 30. In accordance with the five page wide configuration of FIG. 1B, the left outer former 10 comprises an un-utilized region Pₚₐᵣₜ, i.e., the left half of the former 10.

In the contemplated embodiment, the respective former 10, 20 or 30 associated with a part web T1 to T5 also functions as a turner bar which continuously reverses the associated part web T1 to T5 from a horizontal web run into a vertical web run and is turned at this location by 90°, so that the part webs T1 to T5 placed one on top of the other can be jointly fed to the folder 2, as shown in FIG. 6, for example.

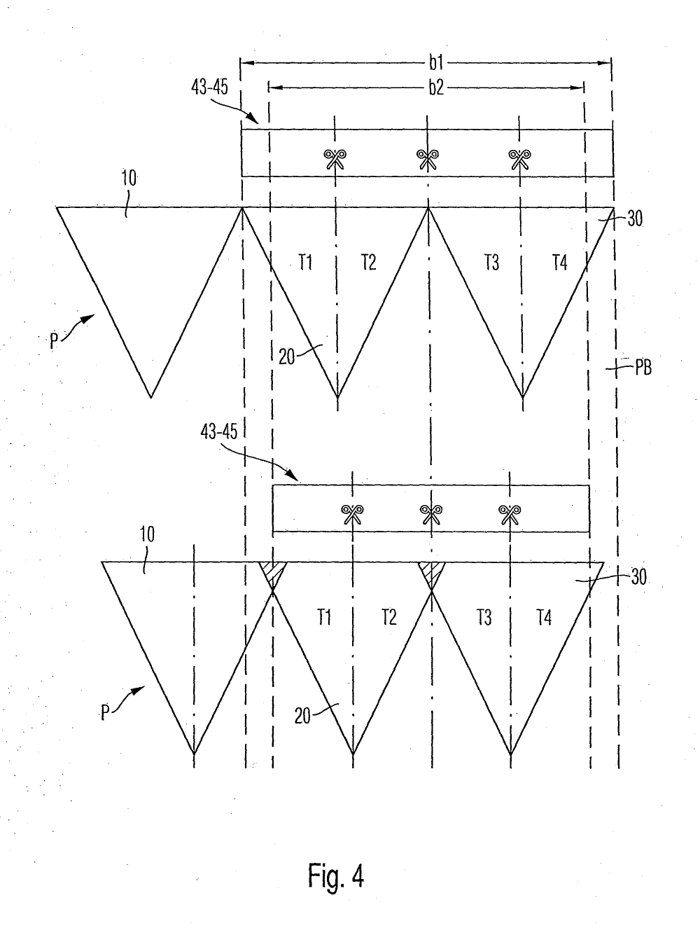

FIG. 1C shows another embodiment of a production configuration of the former arrangement 1 with a web lead in the printing press middle, where along the web width, which can vary between, for example, the maximum web width b1 (see the upper view of FIG. 1C) and the minimum web width b2 (see the lower view of FIG. 1C), four print pages are arranged adjacent to one another. FIG. 4 shows an enlarged view of the production configurations of FIG. 1C.

With reference to FIG. 1C, the substrate web PB is longitudinally cut by at least three longitudinal slitting devices 43 to 45 (the fourth and the fifth longitudinal slitting devices 41, 42 are non-operational) into four part webs T1 to T4 of equal width, so that each part web T1 to T4 carries a print page along the part web width. Here, the at least three formers 10, 20, 30 are each moved to a position corresponding to a four page wide production, so that the four part webs T1 to T4 can each be guided with one of their longitudinal edges to the middle by one of the middle formers 20 or the right outer former 30 while aligned via the middle former 20 or the right former 30. In accordance with the four page wide configuration of FIG. 1C, the left outer former 10 is moved to a “parking” position or out of operation position P in which the former 10 remains substantially un-utilized.

The respective former 20 or 30 associated with a part web T1 to T4 also functions as a turner bar, which continuously reverses the associated part web T1 to T4 from a horizontal web run into a vertical web run and is turned at this location by 90°, so that the part webs T1 to T4 can be, for example, fed to the folder 2 and jointly placed one on top of the other, as shown in FIG. 6.

FIGS. 5A to 5B show a plurality of production configurations of the former arrangement 1 in accordance with the invention, which correspond to the production configurations described with reference to FIGS. 1A to 1C. The configurations of 5A to 5B differ from the configurations of FIGS. 1A to 1C in that the web lead occurs outside the printing press middle (here orientated, for example, towards the drive side) (side 11) of the printing press.

Individually, FIG. 5A shows a production configuration corresponding to the production configuration of FIG. 1A, FIG. 5B shows a production configuration corresponding to the production configuration of FIG. 1B and FIG. 5C shows a production configuration corresponding to the production configuration of FIG. 1C.

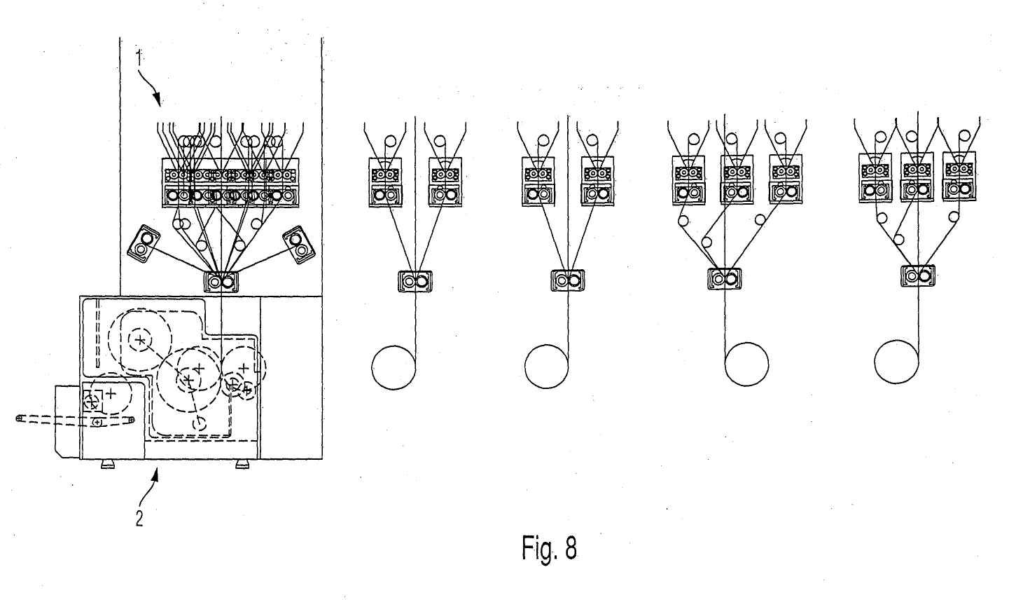

FIG. 8 shows alternative embodiments of the former arrangement 1, with no ribbon lead in the middle between the formers. The embodiments of the formers show the various angles that are obtained as the formers are moved transversely to the web running direction BL.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A former arrangement for processing a substrate web in a reel-fed printing press, comprising:
at least three formers arranged adjacent to each other and transversely to a web running direction of the substrate web; and
at least five longitudinal slitting devices for longitudinally slitting the substrate web into at least two part webs, said at least five longitudinal slitting devices being arranged in front of the at least three formers and being arranged transversely to the web running direction and offset to one another;
wherein the at least three formers and the least five longitudinal slitting devices are each separately moveable transversely to the web running direction.

2. The former arrangement according to claim 1, wherein the at least three formers are moveable to a plurality of predetermined positions corresponding to a four page wide, a five page wide and a six page wide production, respectively.

3. The former arrangement according to claim 2, wherein the at least three formers are each continually moveable in each of said plural predetermined positions in a predetermined region so that positions of the at least three formers are configured into continuously selectable web widths in the predetermined region.

4. The former arrangement according to claim 3, wherein a lead-in roller pair and a nipping roller pair and a frame, which is moveable transversely to the web running direction according to the predetermined positions and arranged in the predetermined region, are provided for each of the at least three formers arranged downstream of a former in the web running direction, and wherein a respective former and associated lead-in roller pair and nipping roller pair in the frame are mounted such that the respective former, the lead-in roller pair and the nipping roller pair are jointly moveable with the frame.

5. The former arrangement according to claim 1, wherein at least two adjacent formers of the at least three formers are each provided with a comb section on adjacent facing sides of the at least two adjacent formers in an upper region of the adjacent facing sides so that the at least two formers engage each other in a comb-like manner in at least one position of a plurality of predetermined positions.

6. The former arrangement according to claim 2, wherein at least two adjacent formers of the at least three formers are each provided with a comb section on adjacent facing sides of the at least two adjacent formers in an upper region of the adjacent facing sides so that the at least two formers engage each other in a comb-like manner in at least one of said plural predetermined positions.

7. The former arrangement according to claim 3, wherein at least two adjacent formers of the at least three formers are each provided with a comb section on adjacent facing sides of the at least two adjacent formers in an upper region of the adjacent facing sides so that the at least two formers engage each other in a comb-like manner in at least one of said plural predetermined positions.

8. The former arrangement according to claim 1, wherein all adjacent formers of the at least three formers are each provided with a comb section in an upper region of the at least three formers so that respective adjacent formers engage each other in a comb-like manner in at least one position of a plurality of predetermined positions.

9. The former arrangement according to claim 2, wherein all adjacent formers of the at least three formers are each provided with a comb section in an upper region of the at least three formers so that respective adjacent formers engage each other in a comb-like manner in at least one of said plural predetermined positions.

10. The former arrangement according to claim 3, wherein all adjacent formers of the at least three formers are each provided with a comb section in an upper region of the at least three formers so that respective adjacent formers engage each other in a comb-like manner in at least one of said plural predetermined positions.

11. The former arrangement according to any one of the claim 4, wherein all adjacent formers of the at least three formers are each provided with a comb section in an upper region of the at least three formers so that respective adjacent formers engage each other in a comb-like manner in at least one of said plural predetermined positions.

12. The former arrangement according to claim 5, wherein a middle former of the at least three formers, which is arranged between two outer formers of the at least three formers, is provided on each side facing the outer formers of the at least three formers with a comb section in an upper region of the middle former, so that the middle former in at least one of the plural predetermined positions engage with the two outer formers of the at least three formers.
